(19) United States
(12) Patent Application Publication
(10) Pub. No.: US 2024/0073518 A1
(43) Pub. Date: Feb. 29, 2024

(54) SYSTEMS AND METHODS TO SUPPLEMENT DIGITAL ASSISTANT QUERIES AND FILTER RESULTS

(71) Applicant: Rovi Guides, Inc., San Jose, CA (US)

(72) Inventors: Vishwas Sharadanagar Panchaksharaiah, Tiptur (IN); Vikram Makam Gupta, Bangalore (IN); Reda Harb, Issaquah, WA (US)

(21) Appl. No.: 17/895,754

(22) Filed: Aug. 25, 2022

(51) Int. Cl. H04N 5/232; G06F 3/01; G10L 15/22

(52) U.S. Cl. CPC H04N 5/23203; G06F 3/017; G10L 15/22; H04N 5/23245; H04N 5/23296

(57) ABSTRACT

Systems and methods for supplementing digital assistant queries and filtering results are disclosed. The methods activate a camera in response to detecting a voice query of a user. The camera captures, in multiple modes, video frames of a user's gestures and/or facial expressions made during utterance of the query and/or the user's environment and/or specific features in the environment present or occurring during utterance of the query. A portion of the query is classified as ambiguous and supplemental data relating to the voice query is requested to resolve the ambiguous portion. Supplemental data may comprise metadata associated with the gestures or facial expressions and/or specific features, actions, or activities during issuance of the query that are extracted from the captured frames. The supplemental data is processed to resolve the ambiguous portions of the query, and the digital assistant responds accordingly to the disambiguated query.

### FIELD OF INVENTION

Embodiments of the present disclosure relate to supplementing voice queries with metadata relating to features extracted from video frames captured while the voice query was uttered.

### BACKGROUND

Digital assistants are widely used for various tasks, such as searching for and watching television shows, shopping, listening to music, setting reminders, controlling smart home devices, among others. Digital assistants listen for a user's voice query and converts the audio signal into a meaningful text query. However, a voice query may include portions which are ambiguous, requiring additional questions to clarify the query, leading to delayed query results for the user. Also, once query results are populated, a user may find it difficult to articulate instructions to the digital assistant to narrow down the results.

When communicating, it is more natural for humans to supplement their speech with body language, such as hand movements, head movements, facial expressions, and other gestures. For example, it is instinctual for humans to react with a smile when excited or react with a frown when disappointed. Users may also expect or attempt to interact with smart assistants the way they do with other humans. For example, a user may point to a screen displaying movie titles and say, “I want to watch this one.” However, the voice query alone lacks context and would require a series of follow up questions to clarify the query (e.g., what is the user referring to by “this one”), such as “Where is the user located?”, “What is the user looking at?”, “How many other selections is the user currently viewing?” “Which of those selections is the user referring to?”, “Is the selection an item of media or some other object?”, “If it is media, is the selection a movie or television show?”, “If it is a movie, what is the title?”, and so forth. Processing a series of follow up questions to clarify a single query can unnecessarily occupy processing resources and result in an inefficient or frustrating user experience. As such, there is a need for improved methods for disambiguating digital assistant queries and filtering results.

### BRIEF DESCRIPTION OF THE FIGURES

The various objects and advantages of the disclosure will be apparent upon consideration of the following detailed description, taken in conjunction with the accompanying drawings, in which like reference characters refer to like parts throughout, and in which:

FIG. 1 is an illustrative diagram of an example process for supplementing a voice query made to a digital assistant, in accordance with some embodiments of the disclosure;

FIG. 2 is a diagram of an illustrative system for supplementing a digital assistant query, in accordance with some embodiments of the disclosure;

FIG. 3 is a flowchart of an exemplary process for supplementing a digital assistant query, in accordance with some embodiments of the disclosure;

FIG. 4 is a flowchart of an exemplary process for disambiguating a digital assistant query, in accordance with some embodiments of the disclosure;

FIG. 5 is a flowchart of an exemplary process for identifying a subject of a digital assistant query, in accordance with some embodiments of the disclosure; and

FIG. 6 is a flowchart of an exemplary process for selecting a mode to capture features for supplementing a digital assistant query, in accordance with some embodiments of the disclosure.

### DETAILED DESCRIPTION

In accordance with some embodiments disclosed herein, some of the above-mentioned limitations are overcome by activating a camera functionality on a user device in response to detecting a voice query, capturing, in multiple modes, a series of frames of the environment from where the voice query is originating, classifying a portion of the voice query as an ambiguous portion, transmitting a request for a supplemental data related to the voice query, wherein the supplemental data relates to the portion of the voice query that was classified as ambiguous, and resolving the ambiguous portion based on processing the supplemental data. As referred herein, supplemental data can include additional data, such as metadata associated with physical gestures made by the user during utterance of the voice query, features (e.g., objects, movements, etc.) in the environment that appear or occur during utterance of the voice query, and so forth.

To accomplish some of these embodiments, video frames of a user and/or the user's environment may be captured during utterance of a voice query. A camera may be configured to be automatically activated and sent a command to capture the frames upon detection of a voice query (for example, upon detection of a wake word or upon the completion of a wake word verification process, or in response to a query or a follow-up query from the assistant, such as “Did you mean . . . ?”). In one embodiment, the activation of the camera to capture an image or a video (series of frames) can be triggered. The frames may be captured via multiple modes, such as through a standard lens, a wide-angle lens, first person gaze, among others. Different modes may be appropriate or optimal for supplementing different queries. The system classifies whether the query includes an ambiguous portion. If the query includes an ambiguous portion, the system may select a mode which captures specific features within the frame. For example, as the user utters the query, the user may simultaneously point to an object in the environment. The user's gesture and the object may be captured in the frame using a wide-angle mode. Supplemental data from the user's gesture and the object is used to resolve the ambiguity of the query. Supplementing digital assistant voice queries with visual input or contextual visual data as described herein reduces the need for follow-up queries otherwise needed for disambiguation, which in turn avoids computational demands required for processing a series of queries. Supplementing voice queries with visual input also reduces the need to use other systems to obtain additional parameters to disambiguate a query, thereby freeing up system resources to perform other tasks.

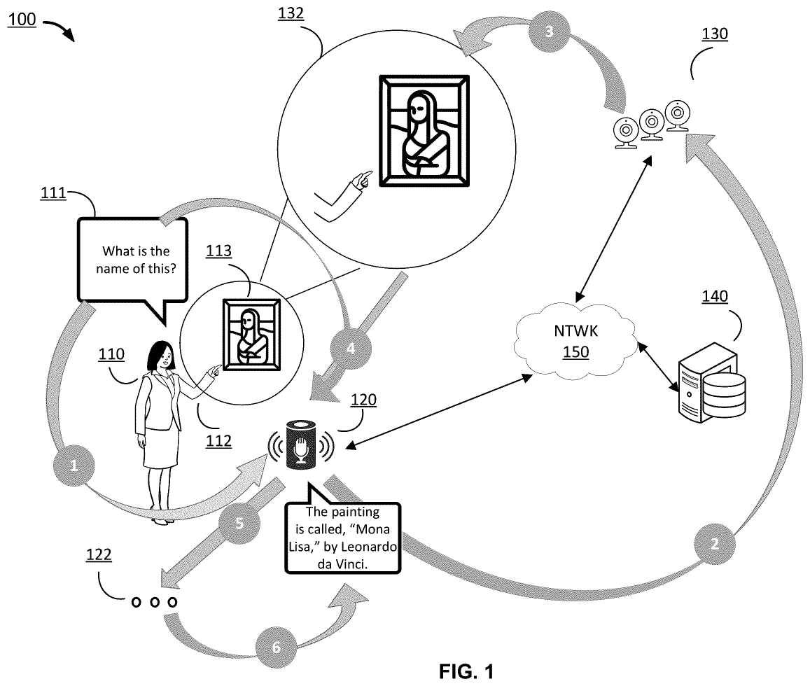

FIG. 1 is an illustrative diagram of an example process 100 for supplementing a voice query made to a digital assistant, in accordance with some embodiments of the disclosure. In one embodiment, at step 1, a user 110 utters a query 111 while making a gesture 112 at a target 113 relating to the query 111. A gesture may be a bodily movement (e.g., hand movement, head movement, eye movement, etc.) or facial expression. In another embodiment, gestures may include biometric data, such as heart rate or blood pressure (e.g., indicating a user's excitement level) and the like. Digital assistant 120 receives the query 111. Digital assistant 120 may be associated with a voice service (e.g., Alexa Voice Services). The voice service may reside on an edge device (e.g., digital assistant 120), on a remote server 140, etc. In the example, user 110 asks, “What is the name of this?” while pointing to the painting in question. In an embodiment, the query may include a wake word, for example, “Hey Alexa, what is the name of this?” In another embodiment, the user's query 111 may be made with or without a wake word and in response to a query from the digital assistant 120, for example, “How may I help you today?”

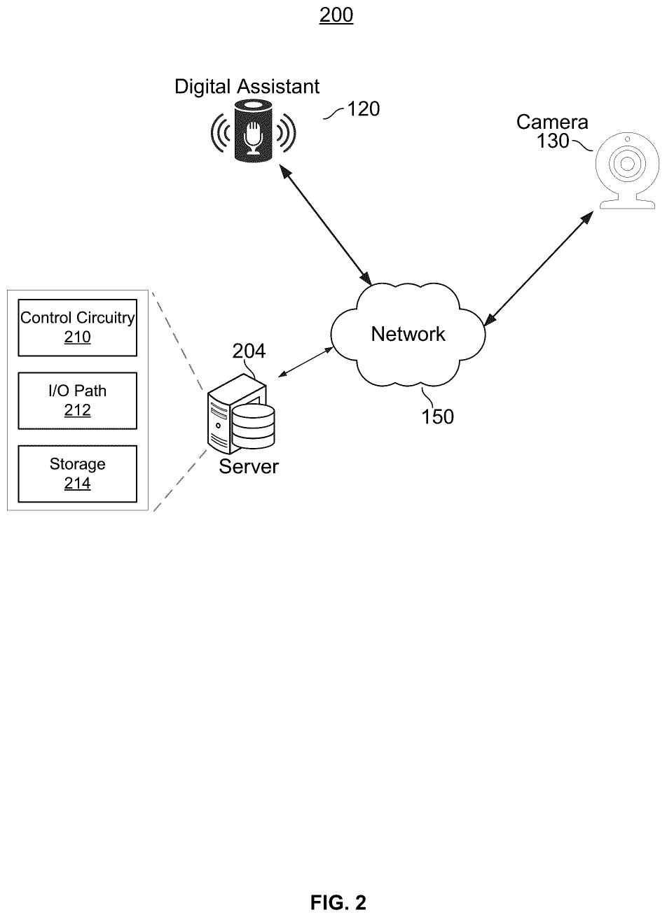

At step 2, upon detecting the query 111, digital assistant 120 activates camera 130 to capture the gesture 112 and target 113. In some embodiments, digital assistant 120 activates camera 130 in response to detecting the initiation of a voice command (e.g., a wake word, wake phrase, etc.) in the query 111. In another embodiment, digital assistant 120 activates camera 130 when wake word verification is completed (e.g., via a cloud-based wake word verification mechanism). In yet another embodiment, digital assistant 120 activates camera 130 in response to a user query that is uttered in response to a query by the digital assistant 120. In an embodiment, camera 130 may be a single camera which can capture frames in multiple modes (e.g., wide angle, standard, zoom-in, etc.). In another embodiment, camera 130 may be an array of cameras. Camera 130 may also be a plurality of cameras that are coupled to a plurality of devices and/or positioned in a plurality of locations (e.g., one camera in the kitchen, one in the living room, etc.). Camera 130 may be in communication with digital assistant 120 over a communication network 150. In other embodiments, the camera(s) is/are integrated with a video-calling device with a built-in smart assistant (e.g., Facebook's portal with Alexa built-in or any smart speaker that is capable of capturing voice commands/queries and processing them locally and/or remotely to respond to the user's commands). More specific implementations of digital assistant and user devices are discussed below in connection with FIG. 2.

In an embodiment, the system determines whether a portion of the query 111 is ambiguous. A portion of the query can be ambiguous if additional questions or information are needed to clarify the meaning of the query. In the example, the query 111, “What is the name of this?” includes an ambiguous portion (e.g., “this”) because receiving the vocal query as audio input alone requires follow up questions to clarify (e.g., provide context for) what “this” refers to. The system requests supplemental data to resolve the ambiguity. In an embodiment, supplemental data can comprise metadata associated with visual input which accompany the utterance of the query, such as gestures made by the user, specific features (e.g., objects, movements, including hand movements or gestures to show estimation of a width or height of an object, etc.) in the environment within frames captured by camera 130, and so forth. The type of supplemental data needed to resolve the ambiguity can be determined based on the query type.

Voice queries with ambiguous portions can be of various query types. As an illustrative example, one query type may direct attention to a target (e.g., wherein a user points to a target object in the environment, picks up a target object from the environment, etc.). Supplemental data for a query type with a directed target may include metadata associated with a gesture and extracting information about the target. Other query types may be uttered and detected by the system. For example, a query type may reference qualities of an object, regardless of whether the object is present in the environment (e.g., user holds up hands to indicate the physical size of an object the user wishes to purchase). Another query type may be location-based or environment-based (e.g., user's query references their location, user's query references the number of people present in a room, etc.). Yet another query type may be a verification or authentication query type (e.g., verify or authenticate the user's identity). Other query types may be used as well.

The mode through which to capture the frames of the environment and/or the user may also be determined based on the query type. In an embodiment, the system can select which mode can capture frames in a manner which enables extraction of the specific feature and collection of its associated metadata. In another embodiment, the system selects a mode which can capture frames in a manner which optimizes extraction of the specific feature and collection of its associated metadata.

In the example at step 3, the query type includes a movement directed at a target (e.g., user 110 points 112 to the target 113 painting). Because the query requires an evaluation of the target 113, the target 113 needs to be identified (e.g., through the captured frames). A wide-angle mode would be inappropriate because the image of the target 113 may be too small to be identifiable. While a standard lens mode may capture an image of the target 113 with sufficient resolution to identify the target 113, a magnified mode (e.g., zoom-in mode 132) would be optimal for camera 130 to capture the details of the painting at a resolution which enables accurate identification (e.g., via known image processing and computer vision algorithms, including optical content recognition) of the painting. In another embodiment, camera 130 may capture initial frames in standard mode to identify the user 110 as the source (also referred to as the “subject”) of the voice query and capture subsequent frames in zoom-in mode to extract details about the targeted object (e.g., painting) with increased accuracy.

In the example at step 4, the query 111 is a query directed at a target (e.g., user 110 points 112 to the painting 113 while uttering query 111). The term “this” is ambiguous in the query 111. Supplemental data may include image frames of the user's 110 pointing gesture 112 that is directed at the target 113, and the target 113 itself. The user's 110 pointing gesture 112 is used to determine that the ambiguous term “this” refers to the object at which the gesture 112 is directed. The object (e.g., the painting) is the specific feature captured in video frames and extracted (e.g., during image or video processing). The system can determine (e.g., by image recognition, etc.) that the targeted object is a painting of the Mona Lisa. At step 5, by supplementing the ambiguous portion of the voice query (e.g., “this”) with visual input captured in multiple modes (e.g., standard frames identifying the user, zoomed-in frames identifying the painting at which the user is pointing) the system disambiguates the query, and returns the appropriate response to the query at step 6.

Clearly, the operations of such system can be distributed. For example, the initial query and images are received from the client, while the processing of the voice query (e.g., automatic speech recognition, determining intent, retrieving search results, etc.) can be performed by one or more services that the client device can access via one or more predefined APIs. Additionally, processing the images and or video snippets (e.g., short videos such as 3 seconds recording) can be do done locally or on a dedicated cloud service. For example, a voice-assist service can be dedicated to analyzing images and or videos by executing preconfigured machine learning and computer vision models to extract contextual information that can assist in responding to the query. However, generating such contextual information can also occur at the client device. For example, pretrained neural network models at the client device can be used to analyze images or video snippets that the voice search service might ask for. In some embodiments, the supplemental data is shared automatically with the voice service. This can occur in response to detecting a gesture that illustrates a size. For example, the user might have used both hands to illustrate a size. Determination of such size can be easily accomplished in image processing. For example, by using a reference object, such as the left hand, its distance to another matching object, such as the user's right hand can be computed using existing image processing algorithms and software libraries. While the voice query is being processed (e.g., automatic speech recognition is being performed and fed to machine learning models to determine the user's intent, etc.), the images and/or video snippets are also being analyzed simultaneously in order to generate a data structure relating the context and information presented in the content that was analyzed. Similarly, the voice-assist service can provide the metadata to the voice service when requested. In such case, the voice-service might query for values that correspond to specific keys as explained below.

In one embodiment the output of the analysis of the video frames includes a list of objects and/or actions that were detected along with confidence values:

```
Oil bottle: 0.54587
  POMPEIAN:0.7845 (using logo on the oil bottle)
Kitchen: xxxxxx
Humans detected: 1
  Reda:xxxxx (identity verification)
Pose: pointing finger
  Object: oil bottle
```

Additionally, the metadata can be grouped in order to share the portion that is requested. For example, if a person was detected and the identity of the person is known, then this information is grouped and shared as related (e.g., in a dictionary structure that provides a list of key:value pairs, list of dictionaries, JSON object, etc.). If an oil bottle was detected and the OCR of the logo reveals its brand, then these 2 data points are also grouped.

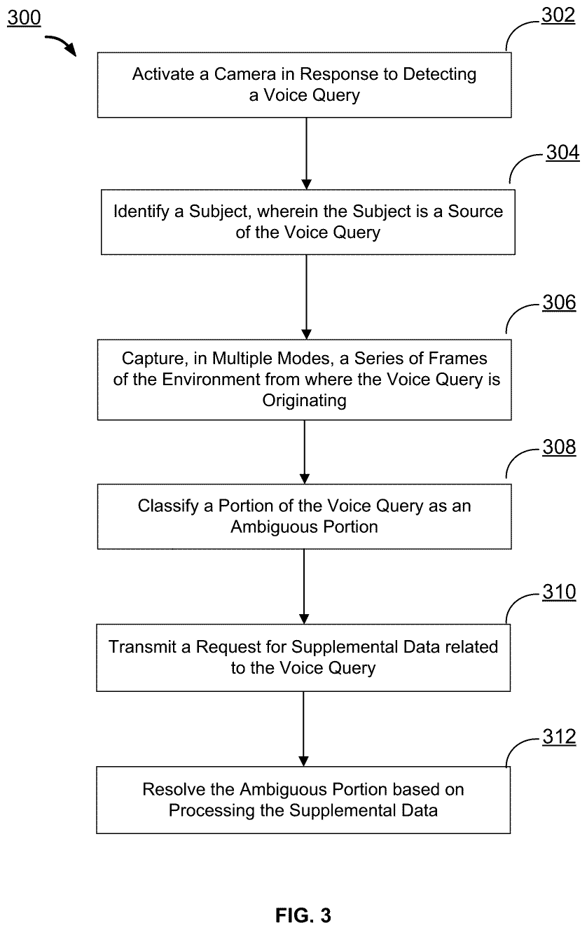

FIG. 2 is a diagram of an illustrative system for supplementing a digital assistant query, in accordance with some embodiments of the disclosure. Camera 130 (which may be, for example, part of digital assistant 120) may be coupled to communication network 150. In some embodiments, camera 130 may be an AI-powered camera with multiple lens built in. Communication network 150 may be one or more networks including the Internet, a mobile phone network, mobile voice or data network (e.g., a 4G or LTE network), cable network, public switched telephone network, or other types of communications network or combinations of communications networks. Paths (e.g., depicted as arrows connecting the respective devices to communication network 306) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 3 to avoid overcomplicating the drawing.

Although communications paths are not drawn between user equipment devices, these devices may communicate directly with each other via communication paths as well as other short-range, point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communication network 150.

System 200 includes digital assistant 120 (i.e., digital assistant 120 in FIG. 1) and server 203. Communications with the digital assistant 120 and server 204 may be exchanged over one or more communications paths but are shown as a single path in FIG. 2 to avoid overcomplicating the drawing. In addition, there may be more than one of each of digital assistant 120, server 204, and camera 130, but only one of each is shown in FIG. 2 to avoid overcomplicating the drawing. If desired, digital assistant 120 and server 204 may be integrated as one source device.

In some embodiments, the server 204 may include control circuitry 210 and storage 214 (e.g., RAM, ROM, Hard Disk, Removable Disk, etc.). The server 204 may also include an input/output path 212. I/O path 312 may provide device information, or other data, over a local area network (LAN) or wide area network (WAN), and/or other content and data to control circuitry 210, which includes processing circuitry, and storage 214. Control circuitry 210 may be used to send and receive commands, requests, and other suitable data using I/O path 212. I/O path 212 may connect control circuitry 204 (and specifically processing circuitry) to one or more communications paths.

Control circuitry 210 may be based on any suitable processing circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 310 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 210 executes instructions for an emulation system application stored in memory (e.g., storage 214).

Memory may be an electronic storage device provided as storage 214 that is part of control circuitry 210. As referred to herein, the phrase “electronic storage device” or “storage device” should be understood to mean any device for storing electronic data, computer software, or firmware, such as random-access memory, read-only memory, hard drives, solid state devices, quantum storage devices, or any other suitable fixed or removable storage devices, and/or any combination of the same. Nonvolatile memory may also be used (e.g., to launch a boot-up routine and other instructions).

Server 204 may retrieve guidance data from digital assistant 120, process the data as will be described in detail below, and forward the data to the camera 130. Digital assistant 120 may include one or more types of smart assistants, including video-calling devices with built-in smart assistants, smart speakers, or other consumer devices with voice-search technology and/or video-capturing capabilities.

Client devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices (such as, e.g., server 204), which may be located centrally or at distributed locations, that provide cloud-based services to various types of users and devices connected via a network such as the Internet via communication network 150. In such embodiments, user equipment devices may operate in a peer-to-peer manner without communicating with a central server.

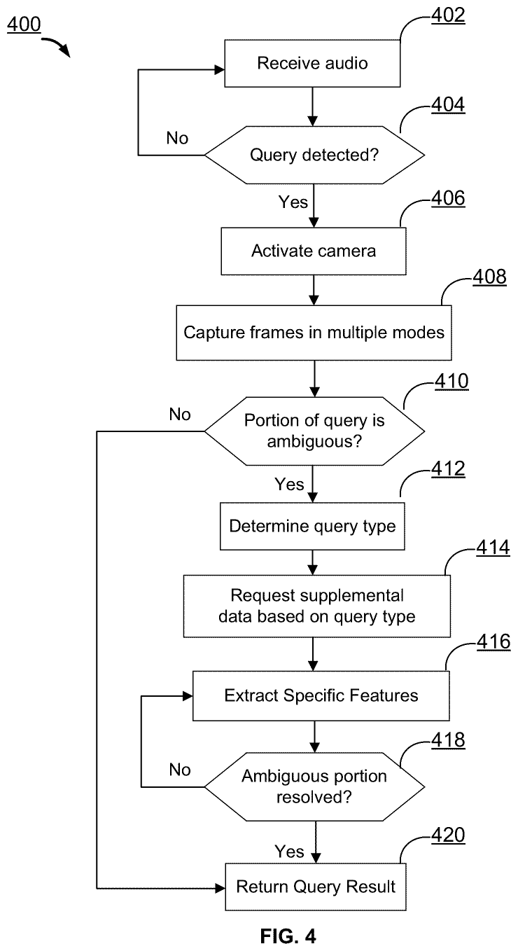

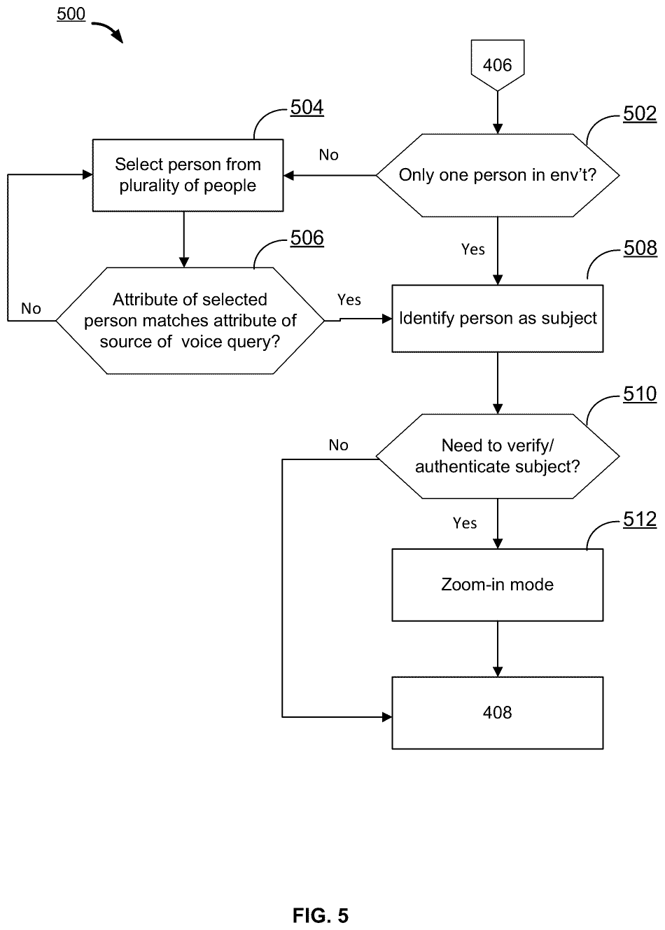

The systems and devices described in FIG. 2 enable not only the illustrative embodiment of FIG. 1, but also the execution of processes described in FIGS. 4-6. It should be noted that each step of processes described in FIGS. 4-5 is performed by the previously described control circuitry (e.g., in a manner instructed to control circuitry 204 or 210 by a content presentation system). It should be noted that the embodiments of FIGS. 4-6 can be combined with any other embodiment in this description and are not limited to the devices or control components used to illustrate the processes.

FIG. 3 is a flowchart of an exemplary process 300 for supplementing a digital assistant query, in accordance with some embodiments of the disclosure. In an embodiment, at step 302, the process activates a camera in response to detecting a voice query. For example, upon detecting a wake word (e.g., “Hey Alexa . . . ”), upon wake word verification, or upon receiving a voice query from a user in response to a digital assistant query (e.g., “How may I assist you?”), a camera functionality in a user device is activated. The user device can be a portable mobile device, laptop, tablet, television set, video-calling devices with built-in smart assistant, etc. In some embodiments, the digital assistant and camera may be on the same device. In another embodiment, multiple cameras may be activated, and a series of images are captured and made available to provide context (e.g., user's location, what the user is hold or pointing at, determine an accurate count of the people that were in the room at a given time, provide updated count after a period of time to the count of people in the room, etc.).

At step 304, the process identifies a subject, wherein the subject is a source of the voice query. In an embodiment, the process may match the voice profile of the source with the voice profile of the user to identify and/or authenticate the user (e.g., among multiple people present in the same environment). In another embodiment, the subject may be identified by matching attributes of the subject and the source. For example, attributes of the user, such as facial features, height, location, etc., may be saved in a database and compared with the attributes of the source of the voice query.

At step 306, the process captures, in multiple modes, a series of frames of the environment from where the voice query is originating. In an embodiment, the multiple modes can include, for example, standard view, wide angle view, fish-eye view, telephoto view, first person gaze, among others. The mode selected can capture the supplemental data (e.g., the user's movement and/or specific feature) within the camera's field of view. In the situation where multiple cameras are used, the camera and its corresponding mode are selected based on whether the user is within the camera's field of view. For example, a first camera is located in the kitchen, while a second camera is located in the living room. If the user utters a query while in the kitchen and accompanied by a group of people, the second camera is activated and a wide-angle mode can be selected.

At step 308, the process classifies a portion of the voice query as an ambiguous portion. In an embodiment, ambiguous queries may be determined based on the query type (e.g., query includes terms with a tendency to be ambiguous, such as “this”, “that,” etc.). In another embodiment, the system may classify (e.g., via machine learning) that a query which follows a particular pattern of query which historically led to an amount of follow up questions above a predetermined threshold.

At step 310, the process transmits a request for supplemental data related to the voice query. In an embodiment, the supplemental data can include data extracted from frames that were captured while the user was uttering or issuing the voice query. In an embodiment, the process identifies the supplemental data based on non-vocal portions of the query. For example, if size is referenced in a query but not specified, the process may ask for metadata associated with the user's hand gestures. In another example, if the request for supplemental data related to a binary response (e.g., yes or no), but the user replies with an ambiguous vocal response (e.g., “mmhmm”), then the process may request metadata related to head movement (e.g., nodding or shaking head).

At step 312, the process resolves the ambiguous portion based on processing the supplemental data. For example, images from the captured frames can be parsed, and contextual information from user's movements (e.g., gestures, facial expression, hand positions, etc.) can be extracted. This supplemental data can be sent along with the vocal query to voice service (e.g., over a cloud network) to accurately determine the meaning of the query and respond accordingly. In an embodiment, supplemental data may be identified in response to determining objects attached to or directed at by the user. For example, it can be determined that the user is holding an oil bottle, and in determining that the user is holding the oil bottle, the brand name of the oil bottle (e.g., via extracting the logo of the bottle under zoom-in mode and/or using brand detection algorithms and or performing optical content recognition.) can be determined. In another embodiment, specific features may be identified with confidence values. Features identified with a higher confidence value are more likely to be an accurate identification. For example, various confidence values may be assigned to specific features captured in the frame (e.g., likelihood that the held object is an oil bottle, brand name of the oil, location of user, user's identity, type of gesture in relation to the object, etc.).

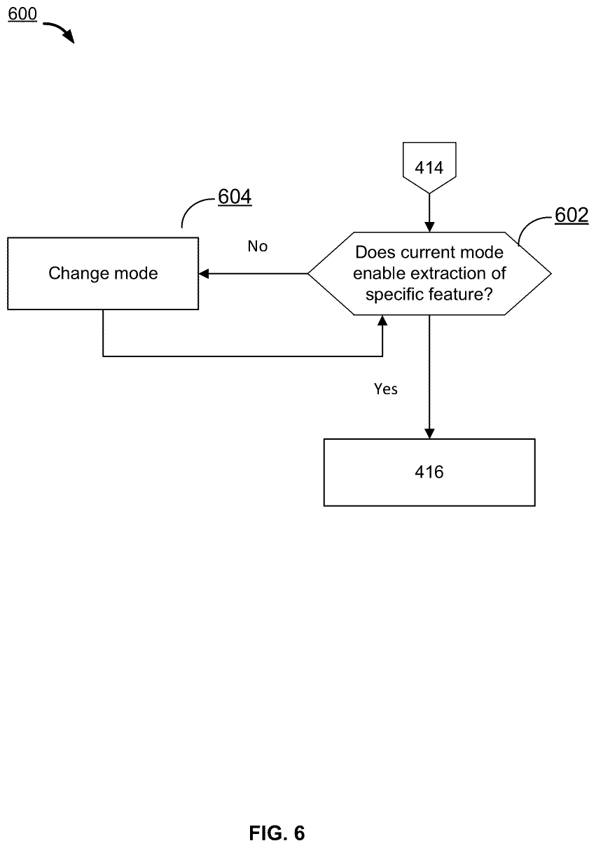

FIG. 4 is a flowchart of an exemplary process 400 for disambiguating a digital assistant query, in accordance with some embodiments of the disclosure. In an embodiment, at step 402, the process receives an audio signal, such as an utterance from a user. At step 404, if a query is detected (e.g., a wake word is detected or verified, etc.), a camera is activated at step 406. At step 408, the camera captures frames of the environment in multiple modes (described in further detail in FIG. 6). At step 410, the process determines whether a portion of the voice query is ambiguous. At step 412, if an ambiguous portion is detected, the process determines the query type. In an embodiment, the process may have predefined categories of query types. In other embodiments, a query type may be determined based on patterns of prior queries (e.g., via machine learning). Based on the query type, supplement data is requested at step 414, and specific features are extracted from the captured frames at step 416.

In some embodiments, query types may be defined by the type of ambiguity involved, the supplemental data needed to resolve the ambiguity, among other factors. For example, one query type may be where a user directs attention to the presence of target in the environment. A user may be pointing at an object in in the environment, the object may be attached to the user (e.g., the user is holding the object, wearing the object, etc.). For example, a user may point to or hold up a bottle of oil while requesting, “Buy another gallon.” Without non-vocal context of the user's gesture or the environment, the voice query alone is ambiguous as to what object the user wants to restock. Resolving the ambiguity in this type of query would require supplemental data relating to the user's gesture, and the targeted object in the environment of that gesture (e.g., metadata indicating that the user is pointing or holding up the oil bottle, and details of the oil bottle itself, such as brand name, flavor, volume, etc.).

Another query type may reference qualities of an object. In some embodiments, the qualities may be referenced, regardless of whether the object is present in the environment. For example, the user may hold up their hands separated at a particular distance and request, “I want to buy a doll this big.” The size of the doll is ambiguous. Thus, supplemental data relating to the size indicated by the user's hand gesture is used to resolve the ambiguity (e.g., “this big”). In an embodiment, supplementing with the gesture can both resolve the ambiguity and narrow search results. For example, the process can understand the query as a request to search for dolls of a particular size available for purchase, and the search results returned to the user will be narrowed to only dolls within a specific size range.

Other query types may relate to filtering results. In some embodiments, such queries can be disambiguated by facial expressions or head movements. For example, a user viewing a list of television shows on a device may instruct the digital assistant to filter the results with additional parameters (e.g., rating, genre, etc.). The digital assistant may display the results, and the camera can capture the user's facial expressions made in reaction to being presented with each result. For example, results which are met with a positive facial expression (e.g., smile, excited look) are saved, while results which are met with negative facial expressions (e.g., boredom, disappointment) are eliminated. In other embodiments, head movements may be used to filter the results (e.g., head nod to approve a search result, head shaking to disapprove search result). In some embodiments, other sensors may be used to capture the reaction of the user for filtering results. For example, biometric sensors (e.g., smart watch, etc.) may be used to detect whether a user expresses excitement, boredom, disappointment, etc., in response to each search result displayed.

Another query type may be one that can be modified based on the gesture or facial expression of the user. For example, when a user utters a query, “Show me the yellow car chase movie,” but is unsure of the query itself, the user may express a puzzled or bemused look. When supplementing the puzzled facial expression with the original query, the system may determine that the query can be expanded, narrowed, or modified in other ways to assist the user in their request. For example, the system may expand the query to “show me the yellow car chase movie, television show, or documentary,” or remove the term “yellow” to modify the query as “show me the car chase movie,” and so forth.

Yet another query type maybe location-based or environment-based. For example, the user may request, “Show me the video bookmarked last week.” The system may determine the location of the user based on the captured frames of the environment to narrow down the list of videos. For example, specific features extracted from the capture frames, such as furniture and fixtures may indicate that the user is in the kitchen. The location will be supplemented to the query as a results filter such that the system produces a list of bookmarked videos pertaining to recipes. In another embodiment, the system may immediately begin playing one of the recipes-related videos, and the user can confirm, cancel, or modify the results with further facial expressions, head movements, etc.

At step 418, when the supplemental data from the extracted features resolve the ambiguous portion, the query results are returned at step 420. In an embodiment, ambiguities may be resolved when specific features from the captured frames removes the need for further clarification on any portion of the original query. In another embodiment, the ambiguous portion is resolved when the specific features are identified with confidence values above a threshold value. For example, a user requests to “Show me my bookmarked videos from last week,” while standing in the kitchen. The system may determine that based on the furniture and fixtures in the capture environment, the identification of the location as a kitchen (e.g., based on presence of stove, refrigerator, sink, etc.) yields a high confidence value, while an identification of the location as a bedroom (e.g., based on lack of stove, refrigerator, and sink, and based on presence of a bed and nightstand) yields a low confidence value. Based on the high confidence value of the location as a kitchen, the system may filter the bookmarked videos to those pertaining to cooking. In yet another example, the ambiguity is resolved when the number of follow up questions to the query falls below a subsequent query threshold (for example, only 0-2 follow up questions remain needed to clarify the original query). Resolving ambiguities in voice queries provides better results to the user and better user experience (e.g., return accurate results more efficiently).

FIG. 5 is a flowchart of an exemplary process for identifying a subject of a digital assistant query, in accordance with some embodiments of the disclosure. Process 500 may, in some embodiments, begin after step 406 of FIG. 4. At step 502, the process determines whether there is only one user in the environment. If other people are present in the environment, the process select one of the people at step 504. At step 506, an attribute of the selected person is compared with the same type of attribute of the source of the voice query. For example, an attribute may include the user's voice profile, visual attributes (e.g., facial features, hair color, height, etc.), the user's location (e.g., determined via Wi-Fi triangulation, 360-degree microphone, etc.), a combination thereof, etc. If the attribute of the user matches that of the source of the query, that user is identified as the subject (step 508). In an embodiment, the attributes of the user and the source may be share similarities above a particular percentage to be considered a match. By identifying the subject, the process can determine which user to include within the field of view of the camera and the captured frames, and which user's movements (e.g., gestures, facial expressions) to use for supplementing the voice query. For example, two people may be present in a room, where a first user stands on the left side and a second user stands on the right side of the room. Both users may be pointing or looking at different objects in the room, but only the first user issues the query. Because the first user's attributes match the attributes of the source of the query (e.g., matching voice profile, the sound of the query emanates from the location where the first user is positioned, etc.), the first user is identified as the subject and only the first user's movements are captured to supplement the query.

At step 510, the process may determine whether verification or authentication is required for the subject. For example, parental restrictions or age restrictions may require the system to confirm that the user is authorized to make certain queries, such as making purchases from the user's online retailer account, or access content. If the execution of such query requires verification or authentication, the process may capture frames of the user in zoom-in mode at step 512. By capturing images of the user in zoom-in mode, supplemental data relating to the user's identity (e.g., facial features, hair color, eye color, height, etc.) may be extracted to supplement the verification or authentication request. Once the user is verified, process 500 continues to step 408 of FIG. 4.

FIG. 6 is a flowchart of an exemplary process 600 for selecting a mode to capture features for supplementing a digital assistant query, in accordance with some embodiments of the disclosure. Process 600 may, in some embodiments, begin after step 414 of FIG. 4. At step 602, the process determines whether the current mode selected enables extraction of the specific feature needed for disambiguating the query. For example, if the query can be disambiguated by being supplemented with data relating to the user's gestures and an object to which the user is pointing, the mode selected should be able to include both the user and the object within its field of view. In another embodiment, the mode selected allows for optimized extraction of supplemental data from the specific feature. For example, while a standard view can capture both the user pointing to a painting and the painting itself within its field of view, a zoom-in mode would be optimal in identifying the details of the painting (e.g., allow for more accurate image recognition).

At step 604, if the current mode does not enable or optimize extraction of the specific feature, the mode is changed. Various modes may correspond to different camera views. For example, frames may be captured in standard mode (e.g., via a standard lens), wide-angle mode, fish-eye mode, telephoto mode, first-person gaze, etc. The system can select from multiple modes, using different modes for supplementing different queries, or a combination of modes for a single query. In an example, a wide-angle mode may be optimal for extracting supplemental data relating to an environment-based query. For example, a user may request, “Order a pizza for everyone.” Capturing frames of the environment in a wide-angle mode allows for capturing all of the people (e.g., “everyone”) within the field of view, to obtain a head count in order to determine the amount of pizza to purchase. Meanwhile, zoom-in mode may be optimal for verification or authentication of a user's identity when a query includes instructions to make purchases from an online account or view content blocked by parental restrictions.

In some embodiments, capturing frames in a combination of modes may be performed consecutively. For example, a first sequence of frames may be captured in a first mode (e.g., standard mode to capture and identify the user pointing at a target), followed by a second sequence of frames captured in a second mode (e.g., zoom in on the targeted object). In another embodiment, the entire set of frames may be captured through multiple modes (e.g., via multiple cameras) at substantially the same time. For example, to filter results displayed on screen viewed by a user, a first camera may capture a user in zoom in mode to track their eye movements on a screen and the user's facial expressions, while a second camera may capture in first person gaze mode the items displayed on the screen.

In another embodiment, changing modes may include rotating the camera to another position. In yet another embodiment, changing modes may include changing cameras. For example, a first camera may be activated in a first room, and a second camera may be later activated in a second room, to follow the user as the user moves from one location to another while issuing the query. Once the appropriate mode (or modes) is selected, process 600 continues to step 416 of FIG. 4.

It will be apparent to those of ordinary skill in the art that methods involved in the above-mentioned embodiments may be embodied in a computer program product that includes a computer-usable and/or -readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method for processing a voice query, comprising:
instructing a user device to activate a camera functionality in response to detecting a voice query;
causing the camera to capture, in multiple modes, a series of frames of the environment from where the voice query is originating;
classifying a portion of the voice query as an ambiguous portion;
transmitting a request for a supplemental data related to the voice query, wherein the supplemental data relates to the portion of the voice query that was classified as ambiguous; and
resolving the ambiguous portion based on processing the supplemental data.

2. The method of claim 1, wherein:
the request for the supplemental data comprises a request for a specific feature extracted from at least one of the captured frames during an utterance of the voice query.

3. The method of claim 1, further comprising:
identifying a subject in the environment, wherein the subject is a source of the voice query; and
determining a location of the subject with respect to the environment.

4. The method of claim 3, wherein:
the supplemental data comprises metadata associated with a gesture performed by the subject during utterance of the voice query.

5. The method of claim 4, wherein the gesture comprises at least one of: a hand movement, a facial expression, and a head movement.

6. The method of claim 1, further comprising:
instructing the camera to zoom in on the identified subject while capturing at least one of the frames.

7. The method of claim 3, further comprising:
identifying the subject, based on an attribute of the subject, from a plurality of subjects in the environment.

8. The method of claim 7, wherein an attribute of the subject comprises at least one of a voice profile associated with the subject, a physical quality of the subject, or the location of the subject.

9. The method of claim 1, wherein the multiple modes include at least one of a standard lens, wide-angle lens, zoom-in, fish-eye lens, telephoto lens, or first person gaze.

10. The method of claim 2, further comprising:
selecting at least one of the multiple modes based on the requested specific feature.

11. The method of claim 1, further comprising:
causing the camera to capture, in a first mode, a first portion of the series of frames of the environment from where the voice query is originating; and
causing the camera to capture, in a second mode, a second portion of the series of frames of the environment from where the voice query is originating.

12. The method of claim 1, wherein a first set of the multiple modes corresponds to a first camera and a second set of the multiple modes corresponds to a second camera.

13. A system for processing a voice query, the system comprising control circuitry configured to:
instruct a user device to activate a camera functionality in response to detecting a voice query;
cause the camera to capture, in multiple modes, a series of frames of the environment from where the voice query is originating;
classify a portion of the voice query as an ambiguous portion;
transmitting a request for a supplemental data related to the voice query, wherein the supplemental data relates to the portion of the voice query that was classified as ambiguous; and
resolving the ambiguous portion based on processing the supplemental data.

14. The system of claim 13, wherein the control circuitry configured to transmit the request for the supplemental data is further configured to:
transmit a request for a specific feature to be extracted from at least one of the captured frames during an utterance of the voice query.

15. The system of claim 13, wherein the control circuitry is further configured to:
identify a subject in the environment, wherein the subject is a source of the voice query; and
determine a location of the subject with respect to the environment.

16. The system of claim 15, wherein the supplemental data comprises metadata associated with a gesture performed by the subject during utterance of the voice query.

17. The system of claim 16, wherein the gesture comprises at least one of: a hand movement, a facial expression, and a head movement.

18. The system of claim 13, wherein the control circuitry is further configured to:
instruct the camera to zoom in on the identified subject while capturing at least one of the frames.

19. The system of claim 15, wherein the control circuitry is further configured to:
identify the subject, based on an attribute of the subject, from a plurality of subjects in the environment.

20. (canceled)

21. The system of claim 13, wherein the multiple modes include at least one of a standard lens, wide-angle lens, zoom-in, fish-eye lens, telephoto lens, or first person gaze.
